(19) United States
(12) Patent Application Publication
(10) Pub. No.: US 2026/0169191 A1
(43) Pub. Date: Jun. 18, 2026

(54) PUR-BASED SCRATCH-RESISTANT COATING AND SYSTEM FOR AUTOMOTIVE LIGHTING

(71) Applicant: VALEO VISION, Bobigny (FR)

(72) Inventor: Robert FRAIZER, Seymour, IN (US)

(73) Assignee: VALEO VISION, Bobigny (FR)

(21) Appl. No.: 18/984,522

(22) Filed: Dec. 17, 2024

(51) Int. Cl. G02B 1/04; F21S 41/275; G02B 1/12; G02B 1/14

(52) U.S. Cl. CPC G02B 1/041; F21S 41/275; G02B 1/12; G02B 1/14

(57) ABSTRACT

The present invention pertains to urethane based polymer coatings with the objective of enhancing the hardness characteristics of light-transmissive polymeric mediums, particularly to applied lenses in automotive lighting. An automotive lighting product of a polyurethane-based (PUR) formulation is derived from an in-mold process that applies thermal cure and ultra-violet (UV) cure processes, as a dual-cure combination, which results in enhanced abrasion and scratch resistance performance that extends lighting product longevity. The PUR-based polymer formulation can reduce pollutant emissions, scrap and waste in the field of the automotive lighting art.

### TECHNICAL FIELD OF THE INVENTION

The present invention relates to enhancing the hardness of polyurethane based (PUR) based coatings in automotive light-transmissive products. More particularly, the present invention relates to enhancing the scratch resistant hardness of light-transmissive automotive lighting products with a coating arrangement that can qualify global regulatory lighting standards while promoting abrasion resistance and lighting performance longevity.

### BACKGROUND OF THE INVENTION

In the automotive field of vehicle lighting, manufacturers are seeking to extend the lifecycle longevity and maintaining performance of polyurethane based (PUR) lens and like light-transmissive products in the automotive field through enhanced coatings. Polyurethane (referenced in the field as PU or PUR for abbreviated convenience) is a chemically manufactured plastic. Among existing problems with the use of PUR materials, is that PUR materials do not ordinarily provide higher levels of scratch or abrasion resistance even when thermally cross-linked, which falls short of meeting automotive lighting regulatory requirements such as FMVSS-108 for legal functions in the U.S. Another existing problem with PUR material usage is that the existing production of in-mold urethane films contain environmentally unfriendly solvents that generally release volatile organic compounds (VOC) during the polymerization and cross-linking process and curing stages.

Accordingly in the automotive field, there is a need for providing more resilient PUR products, which can maintain the transparency levels, prevent material degradation and promote hardened scratch resistance finishes to extend beam performance over the life of an associated lighting product to meet the automotive field's sought after objectives.

### SUMMARY OF THE INVENTION

Accordingly, among the objectives of the present invention is to overcome the above mentioned drawbacks in the state of the art. One objective of the present disclosure is to provide an enhanced coating formulation that can withstand abrasion, enhance scratch resistance or prevent clouding through PUR compositions that promote beam pattern transmission, avoid beam pattern degradation and ensure regulatory lighting performance over the designed service life of vehicles.

Another essential objective is to provide PUR based formulations that will substantially reduce volatile organic compounds during production while enhancing the service life longevity of associated automotive lighting products to ensure performance with regulatory requirements. An additional objective is to promote simplified component production of PUR-based lighting mediums that minimize outgassing and promote more environmentally friendly byproducts that eliminate handling costs and additional treatment logistics.

Among the particulars, the present invention proposes enhancement of a product's look with incorporation of such a lighting innovation and to enhance vehicle aesthetics when adopted with the vehicle's appearance. The present invention also proposes improving the lighting safety and performance of associated products with enhancements beyond currently existing PUR formulations.

These and other objectives of the disclosure may be achieved by one or more of the following aspects. Accordingly, the present invention proposes a non-limiting embodiment of the present invention, that provides an automotive lighting product from a urethane-based (PUR/PUA) formulation derived from a mold tool, thermal cure and ultra-violet (UV) cure processes, comprising: a polymeric substrate that is a light-transmissive medium; a formulation of a number of urethane-based chemical reactants that form a urethane-based composition in an uncured state applied on the polymeric substrate; a number of UV stabilizers and a number of additives added to the urethane-based composition that is configured to achieve a degree of about 85%-90% cross-link density at an abrasion layer of the polymeric substrate [20] that results in enhancements of a hardness characteristic of about 3.2H-4.2H on the Mohs hardness scale; and the abrasion layer rendering the urethane-based composition as a light-transmissive structure in a cured state.

A non-limiting preceding embodiment where the abrasion layer interfaces and covers over a side of the polymeric substrate.

A non-limiting preceding embodiment where the number of UV stabilizers and the number of additives result in a volumetric shrinkage of the automotive lighting product by less than 15 percent after thermal curing and UV curing.

A non-limiting preceding embodiment wherein the abrasion layer attains at least a hardness measurement value of 3.2H on the Mohs hardness scale throughout the abrasion layer after thermal curing and UV curing.

A non-limiting preceding embodiment wherein the scratch resistance results in a measurable value of at least 4.2H on the Mohs hardness scale along the abrasion layer after thermal curing and UV curing.

A non-limiting preceding embodiment wherein the abrasion layer is a thickness of about 12 to 15 microns.

A non-limiting preceding embodiment wherein the thermal cure process produces a cross-linked density of at least about 45 percent and the ultra-violet (UV) cure process supplements a cross-linked density of between 40 to 50 percent at the abrasion layer.

A non-limiting preceding embodiment wherein the measurable value of scratch resistance occurs consistently to a depth of about 7 microns (0.007 mm) from an exterior surface of the polymeric substrate through the abrasion layer.

A non-limiting preceding embodiment wherein the abrasion layer is reduced to an acrylic-urethane film and a supplementary coating is applied over the thickness of the acrylic-urethane film.

A non-limiting preceding embodiment wherein the abrasion layer is reduced to an acrylic-urethane film.

A non-limiting preceding embodiment wherein a seal coat layer over the abrasion layer is a polyurethane based material.

A non-limiting preceding embodiment wherein the number of UV stabilizers includes from among a photo-initiator composition, a photo-inhibitor composition, a UV curable powder coating or a UV-sol-gel coating or some combination thereof.

A non-limiting preceding embodiment wherein the number of additives further includes a blocked acid catalyst or blocked sulfonic acid catalyst or some combination of an acid catalyst.

An alternative non-limiting embodiment of the present invention, that provides a polyurethane-based (PUR) coating composition derived from thermal cure and ultra-violet (UV) cure processes in conjunction with in-mold tooling, the PUR coating composition configured to be applied within an automotive lighting product, comprising: a thickness of film including the PUR coating composition with a number of additives and UV stabilizers; the thickness of film configured to have at least 80% cross-link polymerization upon curing with a measurable hardness characteristic of about 3.2H on the Mohs hardness scale at a surface layer; and the thickness of film having a value of at least 7 microns (0.007 mm); and the PUR coating composition transitioning to a fully cured state after transitioning through a thermal cure and a UV cure process with a negligible amount of outgassing from volatile organic compounds; wherein a time interval between a thermal cure stage and a UV cure stage is about five (5) seconds.

A non-limiting method embodiment of the present invention, providing a method of making an automotive lighting product from a formulation of a polyurethane-based (PUR) composition, an acrylic-urethane (PUA) or unsaturated polyester oligomer material comprising: presenting a mold tool having non-stick coating surfaces; introducing a polymeric substrate that is a light-transmissive medium within a chamber of the mold tool; feeding a stock of the formulation in an uncured state with a number of ultra-violet wavelength (UV) stabilizers and a number of additives into the mold tool where the formulation is transferred to each chamber with the polymeric substrate; curing the formulation by a thermal process and a UV process within a 5-second time interval while the formulation remains in the mold tool such that the automotive lighting product obtains a hardness characteristic value of at least 3.2H on the Mohs hardness scale for a coating layer derived from the formulation on the automotive lighting product; and removing the formulation with the automotive lighting product in a fully cured condition from the mold tool.

A preceding method embodiment where the coating layer maintains the hardness value of at least 3.2H on the Mohs hardness scale to at least a depth of 13 microns (0.013 mm).

A preceding method embodiment where the coating layer maintains the hardness value of at least 4H on the Mohs hardness scale to a depth of 7 microns (0.007 mm).

Variations and modifications can be made to the aforementioned structure without departing from the concepts of the present invention. And it should be appreciated that the above referenced embodiments and examples are non-limiting, as other embodiment variations can exist within the present invention, as shown and described herein. Moreover, such concepts are intended to be covered by the following claims unless these claims by their language expressly state otherwise.

### BRIEF DESCRIPTION OF DRAWINGS

The accompanying drawings that incorporate and constitute a part of the specification, illustrate various embodiments to explain these embodiments together with the description. As such, the accompanying drawings have not necessarily been drawn to scale. Any values dimensions illustrated in the accompanying graphs and figures are for illustration purposes only which may or may not represent actual or preferred values or dimensions. Where applicable, some or all features may not be illustrated to assist in the description of underlying features. In the drawings:

FIG. 1 is a flowchart illustration of a unique single component dual-cure PUR formulation process over the existing PUR processes according to the present invention.

FIG. 2 is an illustration of a single component in-mold, dual-cure process to produce a scratch resistant PUR based formulation according to the present invention.

FIG. 3 is illustrates an in-mold, single component PUR-based formulation applying a dual-cure system for forming a scratch-resistant highly cross-linked coating product according to an exemplary embodiment of the present invention.

FIG. 4 is illustrates an in-mold, multi-component PUR-based formulation applying a chemically cured system for forming a scratch-resistant highly cross-linked coating product according to an alternate embodiment of the present invention.

FIG. 5 is a visual depiction of the single component formulation with curing reaction of a polyurethane-based (PUR) product after the dual-cure process according to an embodiment of the invention.

FIG. 6 illustrates a method of making polyurethane-based (PUR) coating for automotive light-transmissive products with enhanced scratch-resistant characteristics according to a single component dual-cure process according to the present invention.

FIG. 7 illustrates an alternative method of making PUR-based coatings for automotive light-transmissive products having enhanced scratch-resistant characteristics according to a multi-component chemical cure process according to an embodiment of the invention.

### DETAILED DESCRIPTION OF THE INVENTION

The description set forth below as connected with the incorporated drawings are intended as a description of various embodiments of the disclosed subject matter and are not necessarily intended to represent any one select embodiment. In certain instances, the description can include specific details for purposes of providing an understanding of the disclosed embodiments. However, it will be apparent to those skilled in the art that the disclosed embodiments can be practiced without those specific details. In some instances, well-known structures and components can be shown in block diagram form in order to avoid obscuring concepts or design variations of the disclosed subject matter.

Polyurethane (often abbreviated PUR or PU) refers to a class of polymers composed of organic units joined by carbamate (urethane) links. Polyurethane is produced from a wide range of starting materials—in contrast to other common polymers such as polyethylene and polystyrene. Among existing problems with the use of PUR materials, is that PUR materials do not typically provide higher levels of scratch or abrasion resistance even when thermally cross-linked, which falls short of meeting automotive lighting regulatory requirements such as FMVSS-108 for legal functions in the U.S. Also, existing PUR production methods generally require a 2-part (chemical initiator+hardener) formulation that requires a complicated metering process (often difficult to regulate with consistency) before the constituents can be chemically cured within an in-mold production process. And yet another existing problem with PUR material usage is that the existing production of in-mold acrylic-urethane films have environmentally unfriendly solvents which are released as volatile organic compounds (VOC) during the polymerization and cross-linking process in the curing stages.

Among enhancement goals, automakers demand light-transmissive products that will introduce less harmful byproducts into the environment and products that will avoid structural degradation and maintain transparent clarity over a product's service life for ensuring efficient beam transmission. Such a goal allows an extended condition for maintained peak performance of the vehicle lighting products over the vehicle's extended life. It has been a persistent problem that PUR based products become easily scratched, often yellow in-color or become visibly clouded, which adversely can influence beam performance and can cause beam patterns to fall-out of compliance with regulatory standards or contributes to beam performance degradation with the passage of time during service. To date, customers and manufacturers have resorted to chemical solvents, less environmentally friendly processes and more costly preparation steps for producing lighting devices that will meet performance and regulatory requirements. The degradation of PUR-based products in previously applied and current adoptions into the current field has often rendered a vehicle's appearance with such defective PUR lighting products to appear less attractive.

Such conventional practices of applying deficient PUR-based lighting products have led end users with limited options through expensive handling processes and treatments with harmful byproducts or special costly workarounds for making eligibly performing lighting devices. While such approaches can address the PUR material degradation issue and reset the baseline beam performance and aesthetics, customers and manufacturers are less inclined to incur the expenses of adopting such complicated production or more costly treatment formulations to the extent that beam patterns degrade or fall out of regulation.

Also in the automotive field of vehicle lighting, automakers seek to improve coatings on automotive lenses to have higher scratch or abrasion resistance and to possess enhanced adhesion properties as integrated into headlamp products that will consistently qualify regulatory requirements for lighting and signaling functions. Automakers also desire these technical enhancements in more cost effective ways that mutually translate beneficially to satisfy pricing for vehicle makers and consumers in satisfaction ratings, which will further enhance manufacturer brands.

As related to applying enhanced PUR formulations on automotive lighting products, coatings are a covering of material of a particular composition that are applied to the surface of an object or a substrate. The general purpose of applying the coating may be decorative, functional or a combination of both. Coatings can be applied in various states of matter inclusive of solid, liquid, gas or plasma (e.g. powder coatings). In the subject field of automotive lighting, coatings based on polyurethane (PUR) based formulations have not inherently possessed the scratch or abrasion resistance needed to fulfil or perform in-line with regulatory requirements for use in lens or light-transmissive component applications for legal lighting functions in lighting modules. Thus, limiting PUR application to non-lighting functions. Existing PUR approaches by in-mold methods have remained deficient and have not achieved the hardness characteristics required in resulting coatings for legal functions nor have satisfied the customer requirements for long term weathering.

Among the associated enhancement goals, automakers and customers demand headlamp-module performance that will meet automotive regulatory requirements (by example such as FMVSS-108). Addressing coatings in lens and light-transmissive parts can effectively contribute towards this endeavor. Along with this aspect to meet regulatory mandates, improvements of adhesion performance associated with a formulated coating can avoid or effectively prevent delamination in areas susceptible to weathering or wear during the product's lifecycle that can contribute adversely or further degrade module performance expectations.

Recently developed coatings using urethane chemistry through in-mold production have rendered light-transmissive polymeric materials for such coatings with elevated hardness characteristics in measurable ranges of 3.2H-4.2H on the Mohs hardness scale (measure of abrasion) for PUR-based formulations under thermal and UV curing means. As a comparative measure of abrasion values, industrial plastics like acrylic, polycarbonate and Plexiglas generally possess the characteristics 2.5H, 3H and 5H, respectively on the Mohs hardness scale. So such improvements to lens and light-transmissive component applications can result in scratch resistant coatings and enhanced product performance through alternative in-mold PUR production techniques. Such prospective coating development may be extended to automotive lighting lenses, illuminated grills or interior lighting applications while maintaining the attributes of an in-mold system to reduce waste, scrap and undesirable environmental emissions.

Furthermore by combining a dual-cure functionality of the acrylic-urethane coating chemistry (via both the thermal and UV cure methods) through the in-mold process, the coating of a product can be promoted to achieve a highly saturated degree of crosslinked polymerization, which can further increase the surface hardness of an applied product after the initial thermal cure (that produces soft cross-linking) followed up by a secondary UV cure (that produces higher density cross-linking) before ejection from the mold tool-resulting in further scratch and abrasion resistance. A critical aspect of the dual-cure technique can involve transitioning from the thermal cure stage to the UV cure stage within about a five (5) second timeframe while the PUR-based formulation lingers within the mold tool so as to promote the highest degree of cross-link polymerization as the mold tool maintains a heightened temperature from the thermal cure stage. Another critical aspect of this process can be that the mold tool surface be treated with a non-stick coating (such as but not limited to fluoro-polymer compounds like TEFLON) such that interface between the curing PUR-based formulation and mold tool surfaces may ensure a smooth product release in conjunction with an anticipated volumetric shrinkage of the PUR-based formulation coating that is associated with the dual-cure process.

Thus, a combination of thermal and UV curing technologies can allow an in-mold produced clear coating to be applied directly on plastic surfaces without the involvement of complicated chemical metering-mix or the additional treatment or chemical processes that'd adversely contribute to waste, harmful emissions and scrap rates.

Another particular enhancement that automakers demand is the reduction of byproduct contaminants released into the environment. The subject invention can accomplish this with the use of biodegradable solutions and the avoidance of outgassing from VOC (Volatile Organic Compound) in the production of PUR-based coatings without the existing usage of harmful solvents.

Consequently, conventional limitations and practices present significant drawbacks against making resilient anti-scratch formulations, avoidance of lens abrasions or formulating improvements for scratch resistance of PUR-based products. Conventional practices also present significant challenges from preventing premature clouding, yellowing or degradation of lenses and from the losses in performance to qualify and meet regional safety regulations for meeting vehicle safety requirements. Accordingly in the automotive field, there's been a need for more resilient lighting products that can endure vehicle lifecycles to ensure consistent performance for meeting regulatory standards that don't adversely contribute waste or toxicity to environment.

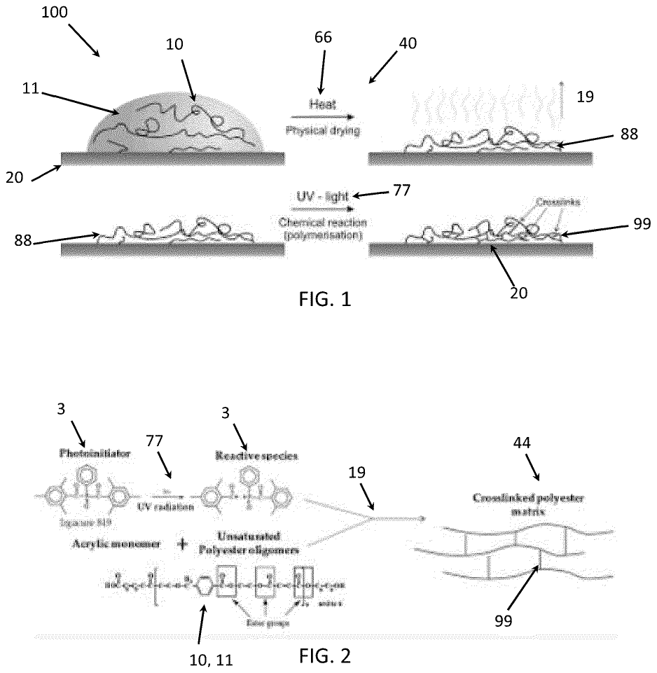

As an alternative to existing 2-part PUR-based processes from existing conventions, the inventors have formulated a distinctively alternate PUR-based formulation process as illustrated in FIG. 1 according to an exemplary embodiment 100 of the present invention. With this unique single-part component approach, an uncured deposit of PUR-based polymeric composition 10 with reactive components 3 and acrylic composition 11 can be specially formulated with UV stabilizers and additives [portions un-numbered as part of 3] to be triggered by UV curing to permit higher degrees of cross-link polymerization and thereby enhance the coating's exterior hardness. The single part component PUR-based formulation can generally include a blend of uncured polymeric composition 10, acrylic composition 11, and reactive components 3 with UV stabilizers and additives apportioned in regulated quantities to manage degrees of cross-linking. As set apart from the currently known 2-part chemical curing processes and conventional approaches, the single component PUR-based uncured formulation is emplaced onto a substrate 20 within a mold tool 40.

As an alternative to existing 2-part PUR-based processes from existing conventions, the inventors have formulated a distinctively alternate PUR-based formulation. This PUR-based uncured formulation is first exposed to a thermal cure means 66 to initiate a soft cross-linking polymerization 88 and then catalyze the hardening of uncured composition 10. In a novel approach of the invention, application of thermal cure means 66 can have the effect of dissipating less environmentally harmful byproduct compounds 19 from the acrylic composition mix 11 into the environment after the stage of thermal cured composition 88. Also with this revised process, a further exposure to ultra violet (UV) cure means 77 by an the UV emission source further catalyzes and increases the hardness of the thermal cured composition and formulated coating composition 88 to elevate the degree of cross-linking and composition density 99 for improving scratch-resistance or abrasion characteristics throughout a coating's 44 depth from its surface—in particular, with the deposited coating material 88 capably being hardened along the surface closest to the UV emission source.

And as previously expressed, a critical aspect of the dual-cure technique can adopt about a 5-second time interval between the thermal cure and the UV cure stage while the PUR-based formulation remains secure within the mold tool so as to promote the highest degree of cross-link polymerization as the mold tool lingers with a heightened temperature from the thermal cure stage. Moreover another previously stated critical aspect with this dual-cure process can be the non-stick coating surface application (such as but not limited to fluoro-polymer compounds) such that the mold tool interface between the curing PUR-based formulation and mold tool surfaces can provide a smooth product release with the experienced volumetric shrinkage of the PUR-based formulation associated with the dual-cure process.

Also with application of the cured formulation to a surface's added abrasion resistance benefit, the chemical reactions from the single component formulation merely produces inert or less harmful byproducts 19, which are an improvement to the previous type of harmful compounds 9 introduced into the environment.

Cross-linking polymerization is a process that joins different polymer chains together to create a more durable material. Cross-linking can be implemented with a covalent or ionic bonds. Cross-linking can be done by reacting polymers with bifunctional molecules, or by irradiating the polymers with UV light sources or high-energy radiation. Cross-linking makes polymers more rigid and durable, and changes their physical properties. The density of cross-links in a polymer affects its mechanical properties. Thus reference to a degree of cross-linking 99 signifies the cross-linking polymerization of this process. A degree of cross-linking closer to 1.0 value generally signifies a fully cross-linked result. So reference in this disclosure to a “heightened degree of cross-linked polymerization” or “increased degree of cross-linking” or “increased degree of composition density” can mean at least 0.78 cross-link value.

It is noted that reference to ultra violet (UV) means 77 signifies irradiation by UV light sources or high-energy radiation such as by non-limiting examples a light-emitting diode (LED) or mercury lamp light source. UV light not only plays a significant role in radiation curing, but is a mandatory trigger for the curing reaction with options of visible, UV-A, UV-B and UV-C with the wavelength ranges of 400-700, 320-400, 280-320 and 100-280 nm, respectively.

Reference to uncured composition 10 can mean a polymer material that has not yet undergone the chemical process of “curing,” meaning the composition is still in a soft, liquid, or pliable state and has not fully hardened into its final form such that the uncured composition is in a form prior to adopting thermal cure means 66 or UV cure means 77. Reference to polymer composition 10 can signify substances of urethane or urethane-based derivations that are the basis of PUR-based formulations in this disclosure. References to acrylic composition 11 can mean substances that provide acrylic monomers that can result in “Polyurethane Acrylate polymer” (PUA) formation, which is a type of polymer created by combining polyurethane with acrylate components. Reference to oligomers or unsaturated polyester oligomer materials can also be constituents to be combined with monomers to producing the described PUR-based formulations. Reactive component 3 refers to chemical elements that can readily undergo chemical reactions with other elements, meaning reactive component 3 has a high tendency to combine with other substances to form new compounds, often releasing energy in the process. Reactive component 3 can include additives or stabilizers as needed to compile PUR formulations as provided by this disclosure.

In FIG. 1, an illustrative flowchart of a distinctive PUR formulation system 100 by dual-cure process 66 77 is visually detailed according to the present invention. In a uniquely distinctive approach, a single component uncured coating composition 10 with reactive components 3 and acrylic composition 11 is emplaced onto a substrate 20 within a mold tool 40 where a thermal process 66 is thereafter applied to initiate a cross-linking process (soft cross-link method) for polymerization, which begins hardening the uncured coating composition 10 into a cured composition 88. a critical aspect of the dual-cure technique can adopt about a 5-second time interval between the thermal cure and the UV cure stage while the PUR-based formulation remains secure within the mold tool so as to promote the highest degree of cross-link polymerization as the mold tool lingers with a heightened temperature from the thermal cure stage.

This thermal cure process 66 has the effect of reducing the embedded ligomer compounds resulting in a volumetric reduction of the cross-linked composition coating 88 and outgassed byproduct 19 as depicted in FIG. 1. A further curing process through applied exposure to ultra violet (UV) means 77 can further facilitate polymerization to heighten the degree of cross-linking 99 thereby enhancing the composition density of the coating 44 and obtaining a more hardened scratch-resistant product, in particular along surfaces closest to the UV emission source (along 44). This is where aspects of the volumetric shrinkage merits mention to applications of non-stick coating to mold tool surfaces 40 that can play a crucial role for successful results of cross-link outcomes such that the mold tool interface between the curing PUR-based formulation and mold tool surfaces can provide a smooth product release with the experienced volumetric shrinkage of the PUR-based formulation associated with the dual-cure process.

FIG. 2 depicts the material constituents of the single component PUR-based formulation by uncured composition 10 and acrylic composition 11 with reactive components 3 that may be combined to implement product system 100, which transforms the substrate 20 to have a hardened abrasion resistant layer 44 from a highly cross-linked byproduct 99. This dual-cure processed highly cross-linked byproduct 99 can result from the uncured PUR-based polymer composition 10 with acrylic composition 11 and reactive components 3 that are blended and first exposed to the thermal cure means 66 and then subsequently exposed to the radiated UV cure means 77 (generally UV light exposure source) to more thoroughly cure (cross-link) for the production of an anti-scratch/abrasion resistant layer 44 that possesses high degrees of cross-linked polymerization. Again, adopting nearly a 5-second time interval between the thermal cure and the UV cure processes can be a crucial aspect of the dual-cure technique while the PUR-based formulation lingers within the mold tool so as to promote the highest degree of cross-link polymerization before the UV cure stage is triggered. And to additionally note with the dual-cure process, one can provide a smooth product release with the anticipated volumetric shrinkage of the PUR-based formulation with surface treatments of the mold tool using non-stick coating prior to the dual-cure process to ensure consistent results.

Seen in an alternative way, FIG. 1 illustrates the dual-cure byproduct 44, which can result from obtaining a thermal cured composition 88 by the initial thermal cure means 66 that is then transformed to the UV cured composition 99 by the second UV cure means 77 (generally UV light exposure source) to produce an anti-scratch/abrasion resistant layer 44 possessing a heightened degree of cross-linked polymerization 99.

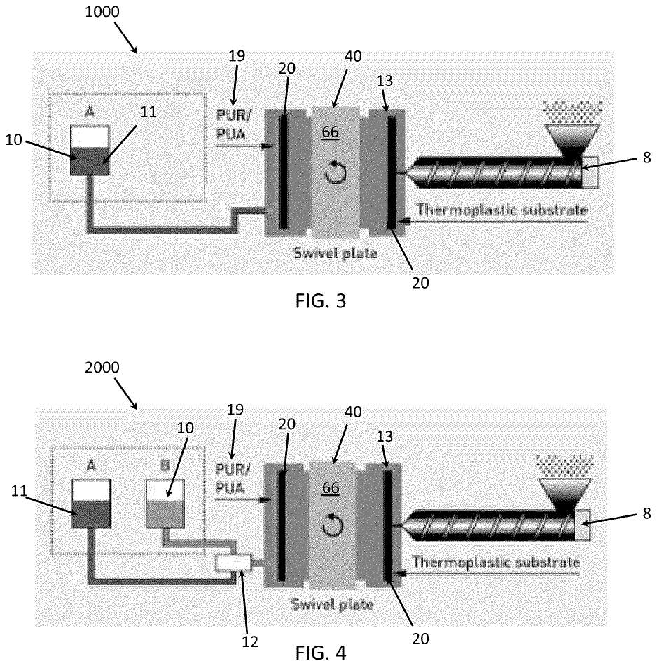

FIG. 3 illustratively describes how the single component PUR-based formulation derived from polymer composition 10 and from reactive constituents 3 of a photo-initiator, acrylic monomer or acrylic composition 11 or unsaturated polyester oligomer materials can be combined in a thermal cure means 66 and then undergo a further process through a UV cure means 77 by exposure to ultra violet (UV) emissions to more thoroughly polymerize and complete cross-linking composition 99 at the coating's exposed surface 44 and further into the coating's depth. The UV cure means 77 combined with thermal cured PUR composition 88 can result in a cross-linked polyester matrix 99, per the FIG. 2 example. The UV curing 77 further increases the hardness of the formulated coating composition 100 and would increase the composition's density (through the increased degree of cross-linking) for attaining a more desirable scratch-resistance or abrasion resistant characteristic through the coating's layer 44—in particular, with the coating material hardening along the surface closest to the UV emission source.

In one embodiment illustrated in FIG. 3, a single component uncured PUR-based polymeric composition 10 and acrylic composition 11 with reactants 3 can be formulated with additives and UV stabilizers deposited onto a light-transmissive medium substrate 20 within a mold tool 40. The mold tool 40 can include a preferred embodiment of a rotatable swivel arrangement with substrate material 20 sourced from a polymeric feed mechanism 8 to facilitate production but should not necessarily be restricted to any particular arrangement (as seen FIG. 3) and may use any feasible arrangement that can work equally well. The uncured PUR-based polymeric composition 10 and acrylic composition 11 with reactants 3 can be injected or transferred to a number of chambers 13 associated with the mold tool 40 that can provide the single component dual-cure constituent compounds that may be pre-mixed, combined or blended together for deposit into the mold tool 40 and ultimately applied to the substrate 20.

FIG. 4 depicts an alternative embodiment multi-component PUR-based formulation where each chamber 13 can source a constituent portion of the uncured polymeric composition 10 and chemical reactants (chemical reactants or solution 11 with chemical additives, stabilizers) from segregate sources like separate vats for each component. As illustrated, a constituent composition from each chamber 13 may be metered or regulated to a control valve or mixer 12 before being directed and deposited to an in-mold section 40, where each section 40 can be appropriately advanced at each stage of the process to receive substrate 20, receive a PUR-based composition injection 10 and acrylic composition 11, and can undergo curing by substantially a chemical-cure process for each respective cure and eject each completed product unit to PUR/PUA product 100. Despite not being illustrated, the PUR-based formulation can adopt time lapse aspects of having no more than a 5-second pause between the thermal cure and the UV cure stages. And PUR-based formulation can incorporate an aspect of applying non-stick coating to the mold tool surfaces to overcome the side-effects of volumetric shrinkage from the dual-cure process.

As depicted by FIG. 1, a PUR-based coating product can be formulated from an uncured PUR-based composition 10 with PUA composition 11 and reactive components 3 that apply a thermal cure process 66 to initiate polymerization and undergo cross-linking for hardening the uncured PUR-based composition 10. During thermal cure process 66, the formulation 10,11 with less environmentally harmful or inert compounds can be dissipated or siphoned off as outgassing byproduct 19 into mold tool 40 during curing from the thermal cured composition 88. Then after thermal cure 66, the PUR based formulation can undergo an additional process of curing by ultra violet emission (UV) means 77 to more fully polymerize and cross-link within the formulated composition 99 from the coating's exposed surface and further into the coating's depth.

Adoption of time lapse aspects of having no longer than a 5-second pause between the thermal cure and the UV cure stages can also contribute to heightened degrees of cross-link. And incorporation of applying non-stick coating to the mold tool surfaces can also contribute favorably to avoid adverse side-effects of volumetric shrinkage from the dual-cure process for obtaining elevated degrees of cross-link polymerization into released products from the mold tool 40. The UV curing process 77 can further increase the hardness of the formulated coating composition 88 to increase the degree of cross-linking or composition density 99 for achieving a desirable scratch-resistance or abrasion characteristic through the coating's layer 44—in particular, with the deposited coating material 99 hardening along the surface closest to the UV emission source.

The substrate 20 can preferably be a thermoplastic material driven to the mold 40 from a hopper feed mechanism 8, which may be reclaimed and would be inherently recyclable at the end of product service life. The substrate material 20 can include a polycarbonate (PC) or polymethyl methacrylate (PMMA) or other similar polymeric material. Also with the added abrasion resistance characteristic benefit, the associated chemical reactions with a more complete curing formulation can merely produce inert and favorable byproducts 19 rather than the harmful volatile organic compounds (VOC) outgassing byproducts with existing processes, which can be an improvement to the existing type of harmful compounds introduced into the environment.

The UV stabilizers can include various photo-initiator compositions, photo-inhibitor compositions, UV curable powder coatings such as a bis-acylphosphineoxide and an α-hydroxy-acetophenone photoinitiator, or UV-sol-gel compositions.

The curing additives can include blocked acid catalysts or blocked sulfonic acid catalysts or various acid catalysts that initiate and accelerate crosslinking of amino resins for industrial thermoset coating systems such as free and blocked sulfonic acid catalysts i.e. PTSA, DDBSA, DNNSA, DNNDSA as well as weak acid catalysts i.e. phosphate-based acid.

The inventive results associated with the PUR/PUA product 100 of a light transmissive medium 20 can include a supplementary coating such as a hardcoat or sealcoat along the coating's exterior surface layer 44. A sealcoat can represent a protective topcoat against weathering, contaminants and degradation. The sealcoat can preferably be a polyurethane-based material or can be another sealant material. The sealcoat can be applied along a surface side of the cured coating 44 either directly or indirectly in combination with other intermediate constituents (i.e. patterned film sections, gradients, optics, etc.). The supplementary coating can be applied by any means such as spray, manual or mechanical application, or through dipping by non-limiting examples.

An anti-mist diffusive coating may also be applied on surfaces of the PUR product. The anti-mist diffusive coating can include a chemical formulation that provides an anti-mist function (moisture concealment material). The anti-mist function can serve to prevent fogging or obstructive moisture accumulation along the coating's surface by hiding water droplets from view. The applied anti-mist function can facilitate water shedding properties through a polyurethane based resin formulation but may primarily act to hide and conceal water droplets rather than working by absorption, through dispersion or having moisture drawn away.

As to coating applicable thickness (T), a scratch-resistant PUR-based coating 44 can be applicably arranged to provide a 7 to 20 micron (0.007-0.020 mm) thickness on a side of the PUR product. In one embodiment, the cured abrasion coating 44 can result with a thickness (T) of about 12 micron to 15 microns (0.012-0.015 mm). In an alternate embodiment, the cured abrasion coating 44 can apply a thickness (T) value in a range between 8 to 12 microns (0.008-0.012 mm) for acceptable results.

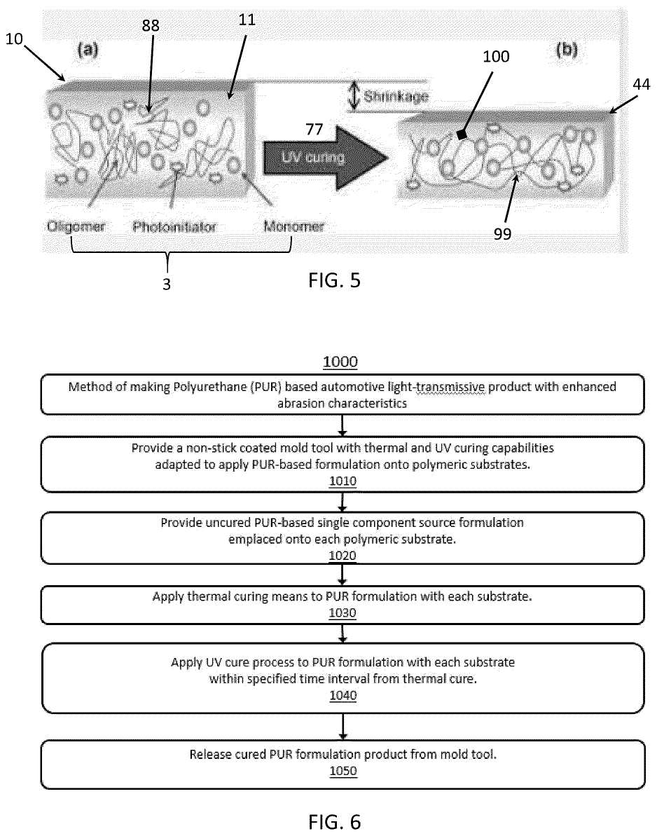

FIG. 5 depicts the effects of volumetric shrinkage of the PUR/PUA based product formulation following the thermal curing 66 and UV curing 77 cycles within a mold tool 40. With the completed curing process of the PUR/PUA based product formulation from stage (a) to stage (b) and increases in the degree of cross-linking, the PUR/PUA formulation can experience a volumetric shrinkage of up to 15% during reduction and outgassing within the mold tool, or generally between 5% to 15% dependent on the PUR-based formulation constituents, which can translate to a thinner dimensional thickness from the originally applied coating thickness in the resultant final product 100 while also facilitating the composition's release from the mold tool 40 as the more thoroughly cured composition recedes from the mold tool surface's 40 interfacing walls. However adoption of non-stick coatings to the mold tool surfaces PUR-based formulation can overcome the side-effects of volumetric shrinkage from the dual-cure process as the mold tool transitions for a smooth product release in conjunction with an anticipated volumetric shrinkage of the PUR-based formulation coating.

FIG. 6 illustratively can depict an exemplary embodiment of the invention that describes the method 1000 of PUR-based formulation coated product with enhanced scratch-resistant characteristics for resilient automotive light-transmissive products. In method 1000, an uncured formulation of PUR-based polymeric composition formulation is provided with UV stabilizers, additives and chemical reactants, which are emplaced onto a polymeric substrate or a light transmissive medium within a mold tool. In method 1000, constituent elements of UV stabilizers, additives and chemical reactants are combined to form the PUR-based formulation derived from a single component source chamber transferred to the mold tool. The method 1000 also provides a non-stick coating surfaced mold tool with thermal curing and UV curing capabilities and provides a feed mechanism for directing polymeric material to the mold tool. Method 1000 can adopt a critical aspect of a 5-second time interval between the thermal cure and the UV cure stages. And method 1000 can incorporate a critical aspect of applying non-stick coating (such as but not limited to fluoro-polymer compounds) to the tooling surfaces to address volumetric shrinkage occurring from the dual-cure process. In method 1000, steps to provide an uncured formulation of PUA-based polymeric composition from a single component source with acrylic composition (PUA) or unsaturated polyester oligomer materials, UV stabilizers, additives and chemical reactants are delivered to the mold tool and perform processes to produce an abrasion or scratch-resistant automotive light-transmissive coated product.

In block method 1010, a mold tool associated with a number of sections and thermal curing and UV curing capabilities is provided along with logistics for receiving polymeric feed material and light-transmissive polymeric substrates. In block 1020, an uncured formulation of PUR-based polymeric composition and reactive components with UV stabilizers, additives and chemical reactants are emplaced onto each polymeric substrate or light-transmissive medium within the mold tool. In a non-limiting way, the mold tool can represent exterior and interior mold sections and can transfer mass between the number of constituent chambers or partitions of developing product at various stages of the process. In block 1030, a thermal curing means can be applied to the uncured PUR formulation on each emplaced polymeric substrate. In block 1040, a UV curing process can be performed within a predetermined timeframe (preferably within 5-seconds) from the thermal cure process for each PUR formulation emplaced on each polymeric substrate. In block 1050, an abrasion resistant light-transmissive product can be derived from the fully cured PUR formulation with each emplaced substrate and can be released by the non-stick coated mold tool.

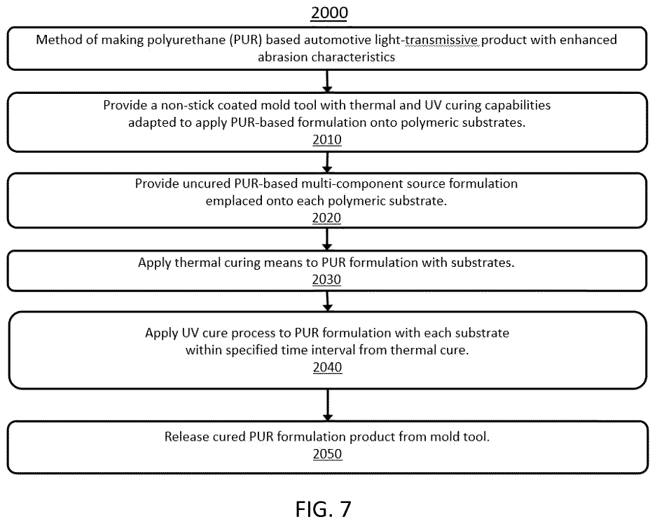

FIG. 7 illustrates an alternate embodiment of the invention and describes the process or method 2000 of making polyurethane (PUR) based automotive light-transmissive coated product with enhanced scratch-resistant characteristics. In method 2000, an uncured formulation of PUR-based polymeric composition formulation is provided with UV stabilizers, additives and chemical reactants, which are emplaced onto a polymeric substrate or a light transmissive medium within a mold tool. In method 2000, constituent elements of UV stabilizers, additives and chemical reactants are combined to form the PUR-based formulation derived from multi-component source chambers transferred to the mold tool. The method 2000 also provides a non-stick coating surfaced mold tool with thermal curing and UV curing capabilities and provides a feed mechanism for directing polymeric material to the mold tool. Method 2000 can also adopt an aspect of a 5-second time interval between the thermal cure and the UV cure stages. Method 2000 can also incorporate an aspect of applying non-stick coating (such as but not limited to fluoro-polymer compounds) to mold tool surfaces to address volumetric shrinkage occurring during the dual-cure process. In method 2000, steps to provide an uncured formulation of PUA-based polymeric composition from multi-component sources of acrylic composition (PUA) or unsaturated polyester oligomer materials, UV stabilizers, additives and chemical reactants are delivered to the mold tool, which perform processes to produce an abrasion or scratch-resistant automotive light-transmissive coated product.

In block method 2010, a mold tool associated with a number of sections and thermal curing and UV curing capabilities is provided along with logistics for receiving polymeric feed material and light-transmissive polymeric substrates. In block 2020, an uncured formulation of PUR-based polymeric composition and reactive components with UV stabilizers, additives and chemical reactants are emplaced onto each polymeric substrate or light-transmissive medium within the mold tool. In a non-limiting way, the mold tool can represent exterior and interior mold sections and can transfer mass between the number of constituent chambers or partitions of developing product at various stages of the process. In block 2030, a thermal curing means can be applied to the uncured PUR formulation on each emplaced polymeric substrate. In block 2040, a UV curing process can be performed within a predetermined timeframe (preferably within 5-seconds) from the thermal cure process for each PUR formulation emplaced on each polymeric substrate. In block 2050, an abrasion resistant light-transmissive product can be derived from the fully cured PUR formulation with each emplaced substrate and can be released by the non-stick coated mold tool.

The methods 1000 and 2000 illustrate sample embodiments of the production process with the PUR, PUA or unsaturated polyester oligomer materials with UV stabilizers, additives and chemical reactants on light-transmissive automotive products that form abrasion-resistant product characteristics and conform to automotive regulatory requirements. Therefore, lighting performance is qualified and enhanced while satisfying market demands with more environmentally friendly manufactured products.

Among the various embodiments, two blocks shown in succession may in-fact be executed substantially concurrently or the associated blocks may sometimes be executed in the reverse order, depending upon the functionality involved, by non-limiting example. It will also be noted that each block of the block diagrams or in the flowchart illustrations or of blocks in the block diagrams or flowchart illustrations, can be implemented by both manual or automated systems that perform the specified functions, or by actions can carry out combinations of special purpose hardware and by control instructions.

It is to be understood that terms such as “front,” “rear,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, and/or points of reference as disclosed herein, and likewise do not necessarily limit embodiments of the present disclosure to any particular configuration or orientation.

Furthermore, the terms “about,” “approximately,” “proximate,” “minor” and similar terms generally refer to ranges that include the identified value within a margin of 20 percent, 10 percent or preferably 5 percent in certain embodiments or any values there between.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

In this text, the term “comprises” and its derivations (such as “comprising”, etc.) should not be understood in an excluding sense, that is, these terms should not be interpreted as excluding the possibility that what is described and defined may include further elements, steps, etc.

Certain recitations contained herein refer to a component being “configured” or “adapted to” function in a particular way. In this respect, such a component is “configured” or “adapted to” embody a particular property or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of or even consists of the elements, ingredients, components or steps.

An automotive lighting product is intended indifferently to mean an exemplary exterior light, a front or rear vehicle light or a lighting module or interchangeably can also be called a headlamp or headlight. As is known, an automotive lighting product can serve as a vehicle's external light having a lighting or signaling function directed towards the outside of the vehicle. The lighting product can potentially serve as a position light, a direction or turn indicator light, daytime running light (DRL), a brake light, a fog light, a reversing light, a low-beam headlight, a high-beam headlight or some combination thereof by way of example.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps. The claimed expression “a number of . . . ” is to be construed to mean or represent “one or more” in countable number such that the expression can represent a singular or multiple number of recited unit elements.

It should be appreciated that the above referenced aspects and examples are non-limiting, as others exist within the present invention as shown and described herein. Unless stated otherwise, dimensions and geometries of the various structures depicted herein are not intended to be restrictive of the invention such that other dimensions or geometries are possible. Plural structural components can be provided by a single integrated structure. Alternatively, a single integrated structure might be divided into separate plural components.

In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

### LIST OF ELEMENT NUMBERS

Coating Thickness T
Reactive Components 3
Polymeric Feed Mechanism 8
Uncured Coating Composition 10
Acrylic Monomer Composition 11
Control Valve-Mixer 12
Mold chamber 13
Outgassing Byproduct 19
Substrate-Light Transmissive Medium 20
Mold Tool 40
Abrasion resistant layer 44
Thermal Cure means 66
Ultra-Violet (UV) Cure Means 77
Thermal Cured Composition 88
UV Cured Composition 99
PUR-based Product System 100
Method to make single component PUR based light-transmissive product 1000
Method to make multi-component PUR based light-transmissive product 2000

1. An automotive lighting product from a urethane-based (PUR/PUA) formulation derived from a mold tool, thermal cure and ultra-violet (UV) cure processes, comprising:
a polymeric substrate that is a light-transmissive medium;
a formulation of a number of urethane-based chemical reactants that form a urethane-based composition in an uncured state applied on the polymeric substrate;
a number of UV stabilizers and a number of additives added to the urethane-based composition that is configured to achieve a degree of about 85%-90% cross-link density at an abrasion layer of the polymeric substrate that results in enhancements of a hardness characteristic of about 3.2H-4.2H on the Mohs hardness scale; and
the abrasion layer rendering the urethane-based composition as a light-transmissive structure in a cured state.

2. The automotive lighting product of claim 1, where the abrasion layer interfaces and covers over a side of the polymeric substrate.

3. The automotive lighting product of claim 1, where the number of UV stabilizers and the number of additives result in a volumetric shrinkage of the automotive lighting product by less than 15 percent after thermal curing and UV curing.

4. The automotive lighting product of claim 1, wherein the abrasion layer attains at least a hardness measurement value of 3.2H on the Mohs hardness scale throughout the abrasion layer after thermal curing and UV curing.

5. The automotive lighting product of claim 1, wherein the scratch resistance results in a measurable value of at least 4.2H on the Mohs hardness scale along the abrasion layer after thermal curing and UV curing.

6. The automotive lighting product of claim 1, wherein the abrasion layer is a thickness of about 12 to 15 microns.

7. The automotive lighting product of claim 1, where the thermal cure process produces a cross-linked density of at least about 45 percent and the ultra-violet (UV) cure process supplements a cross-linked density of between 40 to 50 percent at the abrasion layer.

8. The automotive lighting product of claim 4, where the measurable value of scratch resistance occurs consistently to a depth of about 7 microns (0.007 mm) from an exterior surface of the polymeric substrate through the abrasion layer.

9. The automotive lighting product of claim 1, wherein the abrasion layer is reduced to an acrylic-urethane film and a supplementary coating is applied over the thickness of the acrylic-urethane film.

10. The automotive lighting product of claim 1, wherein the abrasion layer is reduced to an acrylic-urethane film.

11. The automotive lighting product of claim 1, wherein a seal coat layer over the abrasion layer is a polyurethane based material.

12. The automotive lighting product of claim 1, wherein the number of UV stabilizers is included from among a photo-initiator composition, a photo-inhibitor composition, a UV curable powder coating or a UV-sol-gel coating or some combination thereof.

13. The automotive lighting product of claim 1, wherein the number of additives further includes a blocked acid catalyst or blocked sulfonic acid catalyst or some combination of an acid catalyst.

14. A method of making an automotive lighting product from a formulation of
a polyurethane-based (PUR) composition, an acrylic-urethane (PUA) or unsaturated polyester oligomer material comprising:
presenting a mold tool having non-stick coating surfaces;
introducing a polymeric substrate that is a light-transmissive medium within a chamber of the mold tool;
feeding a stock of the formulation in an uncured state with a number of ultra-violet wavelength (UV) stabilizers and a number of additives into the mold tool where the formulation is transferred to each chamber with the polymeric substrate;
curing the formulation by a thermal process and a UV process within a 5-second time interval while the formulation remains in the mold tool such that the automotive lighting product obtains a hardness characteristic value of at least 3.2H on the Mohs hardness scale for a coating layer derived from the formulation on the automotive lighting product; and
removing the formulation with the automotive lighting product in a fully cured condition from the mold tool.

15. The method of making an automotive lighting product of claim 14, where the coating layer maintains the hardness value of at least 3.2H on the Mohs hardness scale to at least a depth of 13 microns (0.013 mm).

16. The method of making an automotive lighting product of claim 14, where the coating layer maintains the hardness value of at least 4H on the Mohs hardness scale to a depth of 7 microns (0.007 mm).

17. A polyurethane-based (PUR) coating composition derived from thermal cure and ultra-violet (UV) cure processes in conjunction with in-mold tooling, the PUR-based coating composition configured to be applied within an automotive lighting product, comprising:
a thickness of film including the PUR-based coating composition with a number of additives and UV stabilizers; the thickness of film configured to have at least 80% cross-link polymerization upon curing with a measurable hardness characteristic of about 3.2H on the Mohs hardness scale at a surface layer; and
the thickness of film having a value of at least 7 microns (0.007 mm); and
the PUR coating composition transitioning to a fully cured state after transitioning through a thermal cure and a UV cure process with a minimal amount of outgassing from volatile organic compounds.
